(19) United States
(12) Patent Application Publication
(10) Pub. No.: US 2026/0280434 A1
(43) Pub. Date: Sep. 17, 2026

(54) POWER CONVERSION DEVICE AND OPERATION METHOD THEREOF

(71) Applicant: Lite-On Technology Corporation, Taipei (TW)

(72) Inventor: Wei Che Wang, Taipei (TW)

(73) Assignee: Lite-On Technology Corporation, Taipei (TW)

(21) Appl. No.: 19/294,314

(22) Filed: Aug. 8, 2025

Related U.S. Application Data
(60) Provisional application No. 63/769,757, filed on Mar. 11, 2025.

(30) Foreign Application Priority Data
Jul. 18, 2025 (TW) 114127307

(51) Int. Cl. H02M 3/335

(52) U.S. Cl. CPC H02M 3/33507

(57) ABSTRACT

Provided are a power conversion device and an operation method thereof. The power conversion device includes an inverter, a transformer, a bidirectional rectifier, and an inductor. An input end of the inverter and an input end of the bidirectional rectifier receive an input DC voltage. The inverter converts the input DC voltage into a first AC voltage for a primary winding of the transformer. A secondary winding of the transformer generates a second AC voltage for the bidirectional rectifier. The bidirectional rectifier uses the second AC voltage to adjust the input DC voltage to generate an adjusted DC voltage for a first end of the inductor. A second end of the inductor provides an output voltage to a load circuit.

### CROSS-REFERENCE TO RELATED APPLICATION

This application claims the priority benefits of U.S. provisional application serial no. 63/769,757, filed on Mar. 11, 2025, and Taiwan application serial no. 114127307, filed on Jul. 18, 2025. The entirety of each of the above-mentioned patent applications is hereby incorporated by reference herein and made a part of this specification.

### BACKGROUND

### Technical Field

The disclosure relates to a power supply equipment, and particularly relates to a power conversion device and an operation method thereof.

### Related Art

Almost all electrical facilities (such as consumer electronic products, charging stations, AI servers, automotive electronic equipment) are indispensable without power conversion devices. How to implement power conversion devices is one of many technical issues in the power field.

### SUMMARY

The disclosure provides a power conversion device and an operation method thereof, to convert an input DC voltage into an output voltage for a load circuit.

In an embodiment of the disclosure, the power conversion device includes an inverter, a transformer, a bidirectional rectifier, and an inductor. An input end of the inverter receives an input DC voltage. The inverter converts the input DC voltage into a first AC voltage. A primary winding of the transformer is coupled to an output end of the inverter to receive the first AC voltage. A secondary winding of the transformer generates a second AC voltage. The bidirectional rectifier is coupled to the secondary winding of the transformer to receive the second AC voltage. An input end of the bidirectional rectifier receives the input DC voltage. The bidirectional rectifier uses the second AC voltage to adjust the input DC voltage to generate an adjusted DC voltage. A first end of the inductor is coupled to an output end of the bidirectional rectifier to receive the adjusted DC voltage. A second end of the inductor provides an output voltage to a load circuit.

In an embodiment of the disclosure, the operation method includes the following. An input DC voltage is converted into a first AC voltage by an inverter of the power conversion device to a primary winding of a transformer of the power conversion device. A second AC voltage is generated by a secondary winding of the transformer to a bidirectional rectifier of the power conversion device. The second AC voltage is used by the bidirectional rectifier to adjust the input DC voltage to generate an adjusted DC voltage to an inductor of the power conversion device. An output voltage is provided by a second end of the inductor to a load circuit.

In an embodiment of the disclosure, the power conversion device includes a battery module, an inverter, a transformer, a rectifier, and an inductor. The inverter is connected in parallel with the battery module. The transformer has a primary winding and a secondary winding, in which the primary winding is coupled to the inverter. The rectifier is connected in series with the battery module and coupled to the secondary winding of the transformer. The inductor is electrically connected to the rectifier.

Based on the above, the inverter and the bidirectional rectifier described in the embodiments of the disclosure receive the same input DC voltage. The input DC voltage is converted into a second AC voltage through the inverter and the transformer. The second AC voltage is used to adjust the input DC voltage to generate an adjusted DC voltage to the inductor, causing the inductor to provide an output voltage to the load circuit. For example, in boost mode, the bidirectional rectifier rectifies the second AC voltage into a rectified voltage to an output end of the bidirectional rectifier. That is, superimposing the rectified voltage on the input DC voltage as the adjusted DC voltage. In other words, the bidirectional rectifier may step up the input DC voltage in the boost mode to generate the adjusted DC voltage to the inductor. In buck mode, the bidirectional rectifier rectifies the second AC voltage into a rectified voltage to an input end of the bidirectional rectifier. That is, subtracting the rectified voltage from the input DC voltage as the adjusted DC voltage. In other words, the bidirectional rectifier may step down the input DC voltage in the buck mode to generate the adjusted DC voltage to the inductor. The inductor provides the output voltage to the load circuit based on the adjusted DC voltage. Therefore, the power conversion device may convert the input DC voltage into the output voltage to the load circuit.

To make the foregoing features and advantages of the disclosure more comprehensible, embodiments are specifically provided below and described in detail together with the accompanying drawings as follows.

### BRIEF DESCRIPTION OF THE DRAWINGS

FIG. 1 is a schematic diagram of a circuit block of an electrical facility according to an embodiment of the disclosure.

FIG. 2 is a schematic flowchart of an operation method of a power conversion device according to an embodiment of the disclosure.

FIG. 3 is a schematic circuit diagram of a bidirectional rectifier and an inverter according to an embodiment of the disclosure.

FIG. 4 is a schematic timing diagram of control signals of the bidirectional rectifier and the inverter in boost mode according to an embodiment of the disclosure.

FIG. 5 is a schematic timing diagram of control signals of the bidirectional rectifier and the inverter in buck mode according to an embodiment of the disclosure.

FIG. 6 is a schematic circuit diagram of the bidirectional rectifier and the inverter according to another embodiment of the disclosure.

FIG. 7 is a schematic circuit block diagram of a power conversion device according to another embodiment of the disclosure.

### DESCRIPTION OF THE EMBODIMENTS

The term "couple (or connect)" used throughout the specification of the disclosure (including the appended claims) may refer to any direct or indirect connection means. For example, if the text describes that a first device is coupled (or connected) to a second device, it should be interpreted that the first device may be directly connected to the second device, or the first device may be indirectly connected to the second device through other devices or some connection means. The terms such as "first", "second", mentioned throughout the specification of the disclosure (including the appended claims) are used to name elements or distinguish different embodiments or scopes, and are not used to limit the upper or lower limit of the number of elements, nor are they used to limit the order of elements. In addition, wherever possible, elements/components/steps using the same reference numerals in the drawings and embodiments represent the same or similar parts. Elements/components/steps using the same reference numerals or the same terms in different embodiments may cross-reference related descriptions. It should be understood that the features of the following embodiments may be combined with each other. For example, the features of the second embodiment may be combined with the features of the first embodiment for implementation. Those having ordinary knowledge in the technical field may select suitable feature combinations according to actual design requirements.

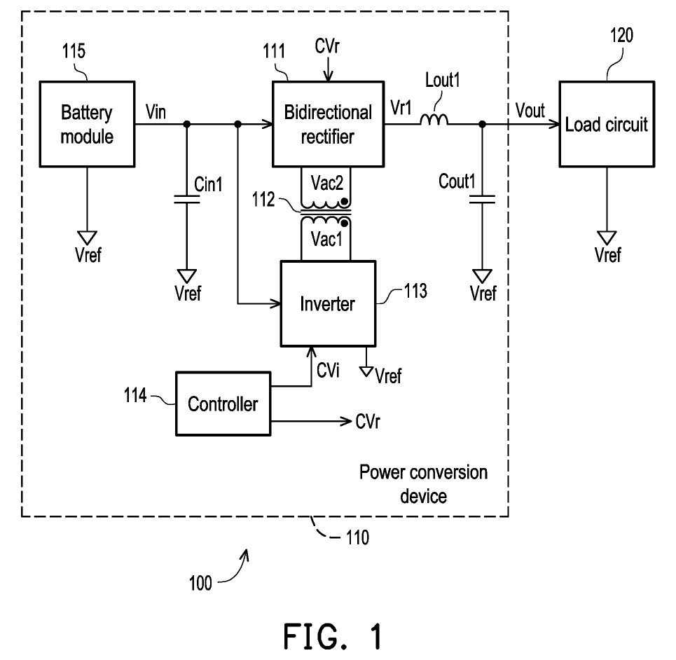

FIG. 1 is a schematic circuit block diagram of an electrical facility 100 according to an embodiment of the disclosure. Based on actual applications, the electrical facility 100 may be consumer electronic products, charging stations, artificial intelligence (AI) servers, automotive electronic equipment, or other facilities. In the electrical facility 100, a power conversion device 110 may convert an input DC voltage Vin provided by a battery module 115 into an output voltage Vout for a load circuit 120. The power terminal of the load circuit 120 is coupled to the power conversion device 110 to receive the output voltage Vout. The reference terminal of the load circuit 120 is coupled to the power conversion device 110 to receive a reference voltage Vref (for example, ground voltage or other fixed voltage).

In the embodiment shown in FIG. 1, the power conversion device 110 includes an input capacitor Cin1, a rectifier (for example, a bidirectional rectifier 111), a transformer 112, an inverter 113, a controller 114, a battery module 115, an inductor Lout1, and an output capacitor Cout1. The inverter 113 is connected in parallel with the battery module 115. The transformer 112 has a primary winding and a secondary winding. The primary winding of the transformer 112 is coupled to the inverter 113. The bidirectional rectifier 111 is connected in series with the battery module 115. The bidirectional rectifier 111 is coupled to the secondary winding of the transformer 112. The inductor Lout1 is electrically connected to the bidirectional rectifier 111. The input capacitor Cin1 is connected in parallel with the inverter 113. The input capacitor Cin1 is electrically connected to the input end of the bidirectional rectifier 111. The output capacitor Cout1 is coupled to the inductor Lout1.

The controller 114 outputs a control signal CVr to control the rectification operation of the bidirectional rectifier 111, and outputs a control signal CVi to control the conversion operation of the inverter 113. According to different designs, in some embodiments, the implementation method of the controller 114 may be a hardware circuit. In other embodiments, the implementation method of the controller 114 may be a combination of multiple ones among hardware, firmware, and software (that is, programs).

In terms of hardware form, the controller 114 may be implemented on logic circuits of an integrated circuit. For example, the related functions of the controller 114 may be implemented in various logic blocks, modules, and circuits among one or more hardware controllers, microcontrollers, hardware processors, microprocessors, application-specific integrated circuits (ASIC), digital signal processors (DSP), field programmable gate arrays (FPGA), central processing units (CPU), and/or other processing units. The related functions of the controller 114 may be implemented as hardware circuits using hardware description languages (for example, Verilog HDL or VHDL) or other suitable programming languages, such as various logic blocks, modules, and circuits in integrated circuits.

In terms of software form and/or firmware form, the related functions of the controller 114 may be implemented as programming codes. For example, the controller 114 is implemented using general programming languages (for example, C, C++ or assembly language) or other suitable programming languages. The programming codes may be recorded/stored in a "non-transitory machine-readable storage medium". In some embodiments, the non-transitory machine-readable storage medium includes, for example, semiconductor memory and/or storage devices. Electronic devices (for example, computers, CPUs, hardware controllers, microcontrollers, hardware processors or microprocessors) may read and execute the programming codes from the non-transitory machine-readable storage medium, thereby implementing the related functions of the controller 114.

The input end of the inverter 113 and the input end of the bidirectional rectifier 111 receive the same input DC voltage Vin. Based on actual application scenarios, the input DC voltage Vin may be provided by a battery or other DC power source. A first end of the input capacitor Cin1 is coupled to the input end of the inverter 113 and the input end of the bidirectional rectifier 111 to receive the input DC voltage Vin. A second end of the input capacitor Cin1 receives a reference voltage Vref (for example, ground voltage or other fixed voltage).

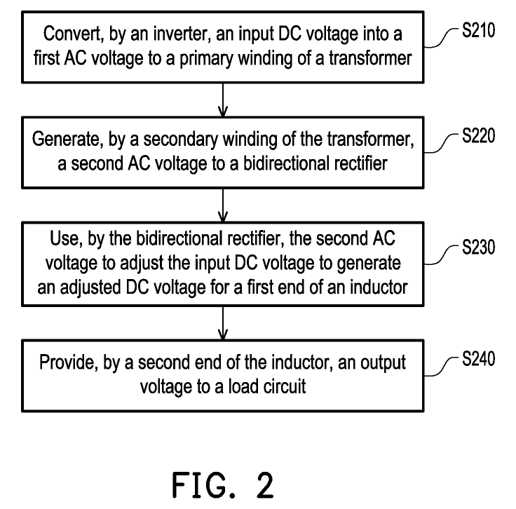

FIG. 2 is schematic flowchart of an operation method of a power conversion device according to an embodiment of the disclosure. Referring to FIG. 1 and FIG. 2, in Step S210, the inverter 113 converts the input DC voltage Vin into an AC voltage Vac1 to a primary winding of the transformer 112. The primary winding of the transformer 112 is coupled to the output end of the inverter 113 to receive the AC voltage Vac1. Based on the energy of the primary winding, a secondary winding of the transformer 112 generates an AC voltage Vac2 to the bidirectional rectifier 111 (Step S220). The bidirectional rectifier 111 is coupled to the secondary winding of the transformer 112 to receive the AC voltage Vac2.

In Step S230, the bidirectional rectifier 111 uses the AC voltage Vac2 to adjust the input DC voltage Vin to generate an adjusted DC voltage Vr1 to the inductor Lout1. A first end of the inductor Lout1 is coupled to the output end of the bidirectional rectifier 111 to receive the adjusted DC voltage Vr1. Based on the adjusted DC voltage Vr1, a second end of the inductor Lout1 provides an output voltage Vout to the load circuit 120 (Step S240). A first end of the output capacitor Cout1 is coupled to the second end of the inductor Lout1. A second end of the output capacitor Cout1 receives the reference voltage Vref.

The controller 114 controls the rectification operation of the bidirectional rectifier 111 through the control signal CVr, and controls the conversion operation of the inverter 113 through the control signal CVi. For example, in response to the power conversion device 110 operating during a conversion period, the controller 114 enables the inverter 113 to convert the input DC voltage Vin into the AC voltage Vac1 to the transformer 112, and the bidirectional rectifier 111 uses the AC voltage Vac2 output by the transformer 112 to adjust the input DC voltage Vin to generate the adjusted DC voltage Vr1 to the inductor Lout1. In response to the power conversion device 110 operating during a free-wheeling period after the conversion period, the controller 114 disables the inverter 113 to stop outputting the AC voltage Vac1 to the transformer 112, and the bidirectional rectifier 111 outputs the input DC voltage Vin as the adjusted DC voltage Vr1 to the inductor Lout1.

In summary, the bidirectional rectifier 111 and the inverter 113 receive the same input DC voltage Vin. The input DC voltage Vin is converted to the AC voltage Vac2 through the inverter 113 and the transformer 112. The AC voltage Vac2 is used to adjust the input DC voltage Vin to generate the adjusted DC voltage Vr1 to the inductor Lout1, causing the inductor Lout1 to provide the output voltage Vout to the load circuit 120. For example, in the boost mode, the bidirectional rectifier 111 rectifies the AC voltage Vac2 to a rectified voltage to the output end (the right end of the bidirectional rectifier 111) of the bidirectional rectifier 111, that is, superimposes the rectified voltage on the input DC voltage Vin as the adjusted DC voltage Vr1. In other words, the bidirectional rectifier 111 may boost the input DC voltage Vin in the boost mode to generate the adjusted DC voltage Vr1 to the inductor Lout1. In the buck mode, the bidirectional rectifier 111 rectifies the AC voltage Vac2 to a rectified voltage to the input end (the left end of the bidirectional rectifier 111) of the bidirectional rectifier 111, that is, subtracts the rectified voltage from the input DC voltage Vin as the adjusted DC voltage Vr1. In other words, the bidirectional rectifier 111 may step down the input DC voltage Vin in the buck mode to generate the adjusted DC voltage Vr1 to the inductor Lout1. The inductor Lout1 provides the output voltage Vout to the load circuit 120 based on the adjusted DC voltage Vr1. Therefore, the power conversion device 110 may convert the input DC voltage Vin to the output voltage Vout to the load circuit 120.

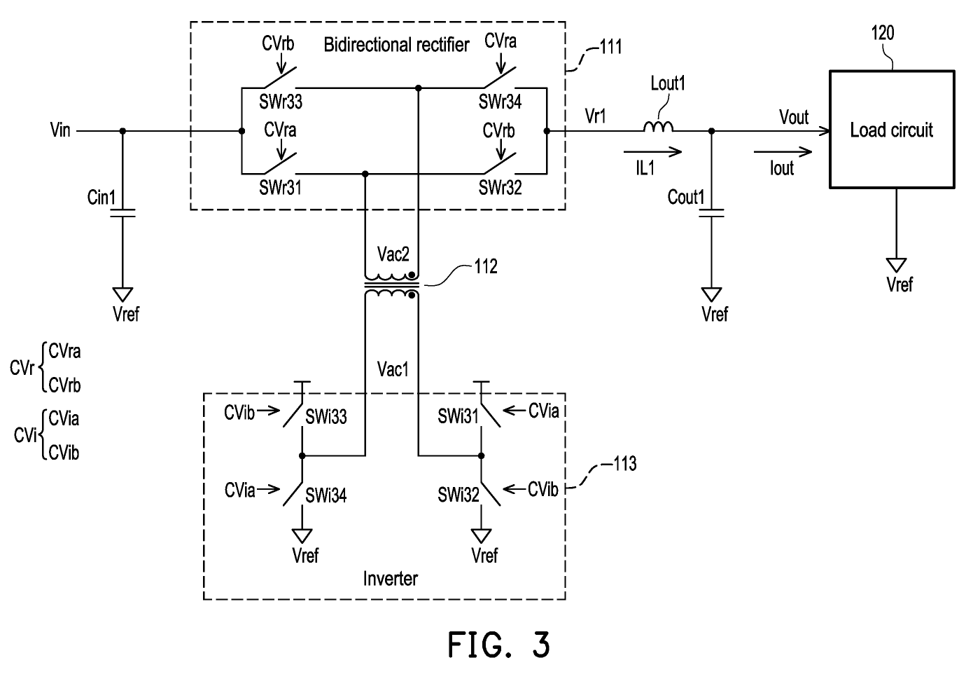

FIG. 3 is a circuit diagram of the bidirectional rectifier 111 and the inverter 113 according to an embodiment of the disclosure. The bidirectional rectifier 111 and the inverter 113 shown in FIG. 3 may serve as one of many implementation examples of the bidirectional rectifier 111 and the inverter 113 shown in FIG. 1. For the input capacitor Cin1, the bidirectional rectifier 111, the transformer 112, the inverter 113, the inductor Lout1, the output capacitor Cout1, and the load circuit 120 shown in FIG. 3, reference may be made to the related description of FIG. 1, so details will not be repeated here. In the embodiment shown in FIG. 3, the inverter 113 includes a power transistor SWi31, a power transistor SWi32, a power transistor SWi33, and a power transistor SWi34. A first end of the power transistor SWi31 is coupled to an input end of the inverter 113 to receive the input DC voltage Vin. A second end of the power transistor SWi31 is coupled to a first end of a primary winding of the transformer 112. A first end of the power transistor SWi32 is coupled to the second end of the power transistor SWi31. A second end of the second power transistor SWi32 receives a reference voltage Vref. A first end of the power transistor SWi33 is coupled to the input end of the inverter 113 to receive the input DC voltage Vin. A second end of the power transistor SWi33 is coupled to a second end of the primary winding of the transformer 112. A first end of the power transistor SWi34 is coupled to the second end of the power transistor SWi33. A second end of the power transistor SWi34 receives the reference voltage Vref.

In the embodiment shown in FIG. 3, the bidirectional rectifier 111 includes a switch circuit SWr31, a switch circuit SWr32, a switch circuit SWr33, and a switch circuit SWr34. A first end of the switch circuit SWr31 and a first end of the switch circuit SWr33 are coupled to the input end of the bidirectional rectifier 111 to receive the input DC voltage Vin. A second end of the switch circuit SWr31 is coupled to a second end of a secondary winding of the transformer 112. A second end of the switch circuit SWr33 is coupled to a first end of the secondary winding of the transformer 112. A first end of the switch circuit SWr32 is coupled to the second end of the switch circuit SWr31. A first end of the switch circuit SWr34 is coupled to the second end of the switch circuit SWr33. A second end of the switch circuit SWr32 and a second end of the switch circuit SWr34 are coupled to the output end of the bidirectional rectifier 111 to provide the adjusted DC voltage Vr1 to output to the inductor Lout1.

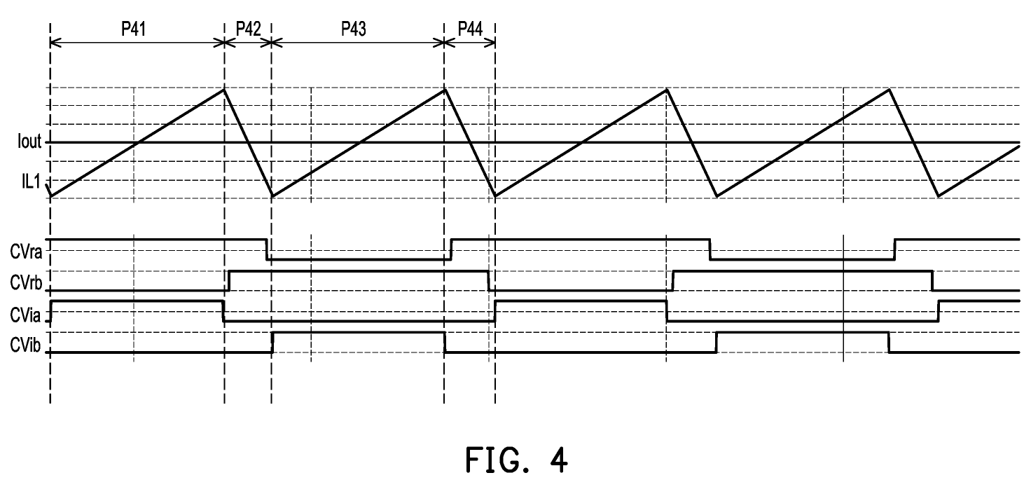

FIG. 4 is a timing diagram of control signals of the bidirectional rectifier 111 and the inverter 113 in boost mode according to an embodiment of the disclosure. The horizontal axis in FIG. 4 represents time. Referring to FIG. 3 and FIG. 4, the control signal CVr includes control signals CVra and CVrb, and the control signal CVi includes control signals CVia and CVib. In addition to the control signals CVra, CVrb, CVia, and CVib, FIG. 4 also illustrates a current IL1 of the inductor Lout1 and an output current Iout of the power conversion device 110. In response to the power conversion device 110 operating during a conversion period P41 in boost mode, the control signal CVia turns on the power transistors SWi31 and SWi34, the control signal CVra turns on the switch circuits SWr31 and SWr34, the control signal CVib turns off the power transistors SWi32 and SWi33, and the control signal CVrb turns off the switch circuits SWr32 and SWr33. At this time, current flows from the conducting switch circuit SWr31 through the secondary winding of the transformer 112 to the conducting switch circuit SWr34. The bidirectional rectifier 111 rectifies the AC voltage Vac2 into a rectified voltage to the output end (the right end of the bidirectional rectifier 111) of the bidirectional rectifier 111. That is, the bidirectional rectifier 111 superimposes the input DC voltage Vin on the rectified voltage as the adjusted DC voltage Vr1.

In response to the power conversion device 110 operating during a free-wheeling period P42 (the free-wheeling period P42 is after the conversion period P41) in boost mode, the control signals CVra and CVrb turn on the switch circuits SWr31, SWr32, SWr33, and SWr34, and the control signals CVia and CVib turn off the power transistors SWi31, SWi32, SWi33, and SWi34. In response to the power conversion device 110 operating during a conversion period P43 (the conversion period P43 is after the free-wheeling period P42) in boost mode, the control signal CVia turns off the power transistors SWi31 and SWi34, the control signal CVra turns off the switch circuits SWr31 and SWr34, the control signal CVib turns on the power transistors SWi32 and SWi33, and the control signal CVrb turns on the switch circuits SWr32 and SWr33. At this time, current flows from the conducting switch circuit SWr33 through the secondary winding of the transformer 112 to the conducting switch circuit SWr32. The bidirectional rectifier 111 rectifies the AC voltage Vac2 into a rectified voltage to the output end (the right end of the bidirectional rectifier 111) of the bidirectional rectifier 111. That is, the bidirectional rectifier 111 superimposes the input DC voltage Vin on the rectified voltage as the adjusted DC voltage Vr1. In response to the power conversion device 110 operating during a free-wheeling period P44 (the free-wheeling period P44 is after the conversion period P43) in boost mode, the control signals CVra and CVrb turn on the switch circuits SWr31, SWr32, SWr33, and SWr34, and the control signals CVia and CVib turn off the power transistors SWi31, SWi32, SWi33, and SWi34. In summary, the bidirectional rectifier 111 may boost the input DC voltage Vin in boost mode to generate the adjusted DC voltage Vr1 to the inductor Lout1.

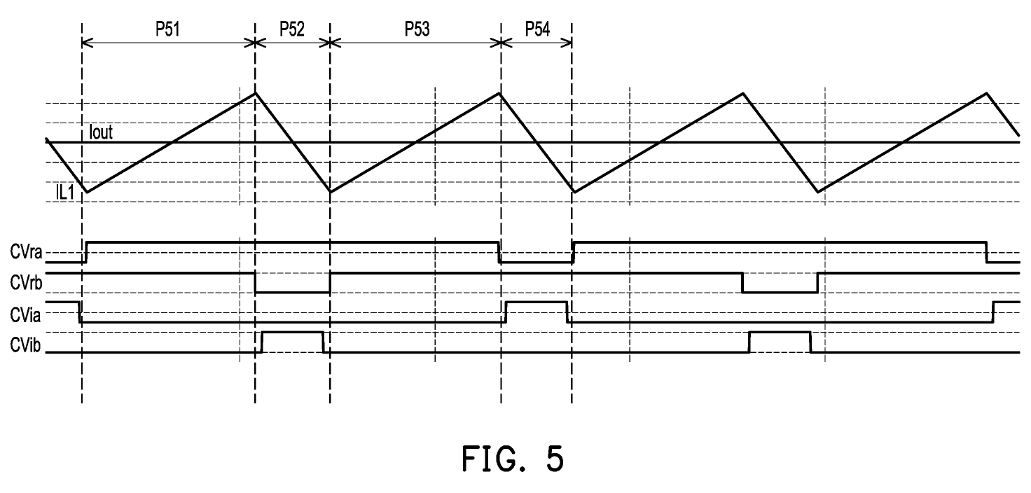

FIG. 5 is a timing diagram illustrating of control signals of the bidirectional rectifier 111 and the inverter 113 in buck mode according to an embodiment of the disclosure. The horizontal axis in FIG. 5 represents time. Referring to FIG. 3 and FIG. 5, the control signal CVr includes control signals CVra and CVrb, and the control signal CVi includes control signals CVia and CVib. In addition to the control signals CVra, CVrb, CVia, and CVib, FIG. 5 also illustrates the current IL1 of the inductor Lout1 and the output current Iout of the power conversion device 110. In response to the power conversion device 110 operating during a free-wheeling period P51 in buck mode, the control signals CVra and CVrb turn on the switch circuits SWr31, SWr32, SWr33, and SWr34, and the control signals CVia and CVib turn off the power transistors SWi31, SWi32, SWi33, and SWi34. In response to the power conversion device 110 operating during a conversion period P52 (the conversion period P52 is after the free-wheeling period P51) in buck mode, the control signal CVia turns off the power transistors SWi31 and SWi34, the control signal CVrb turns off the switch circuits SWr32 and SWr33, the control signal CVib turns on the power transistors SWi32 and SWi33, and the control signal CVra turns on the switch circuits SWr31 and SWr34. At this time, current flows from the conducting switch circuit SWr34 through the secondary winding of the transformer 112 to the conducting switch circuit SWr31. The bidirectional rectifier 111 rectifies the AC voltage Vac2 into a rectified voltage to the input end (the left end of the bidirectional rectifier 111) of the bidirectional rectifier 111. That is, the bidirectional rectifier 111 subtracts the rectified voltage from the input DC voltage Vin as the adjusted DC voltage Vr1.

In response to the power conversion device 110 operating during a free-wheeling period P53 (the free-wheeling period P53 is after the conversion period P52) in buck mode, the switch circuits SWr31, SWr32, SWr33, and SWr34 are turned on, and the power transistors SWi31, SWi32, SWi33, and SWi34 are turned off. In response to the power conversion device 110 operating during a conversion period P54 (the conversion period P54 is after the free-wheeling period P53) in buck mode, the control signal CVia turns on the power transistors SWi31 and SWi34, the control signal CVrb turns on the switch circuits SWr32 and SWr33, the control signal CVib turns off the power transistors SWi32 and SWi33, and the control signal CVra turns off the switch circuits SWr31 and SWr34. At this time, current flows from the conducting switch circuit SWr32 through the secondary winding of the transformer 112 to the conducting switch circuit SWr33. The bidirectional rectifier 111 rectifies the AC voltage Vac2 into a rectified voltage to the input end (the left end of the bidirectional rectifier 111) of the bidirectional rectifier 111. That is, the bidirectional rectifier 111 subtracts the rectified voltage from the input DC voltage Vin as the adjusted DC voltage Vr1. In summary, the bidirectional rectifier 111 may step down the input DC voltage Vin in the buck mode to generate the adjusted DC voltage Vr1 to the inductor Lout1.

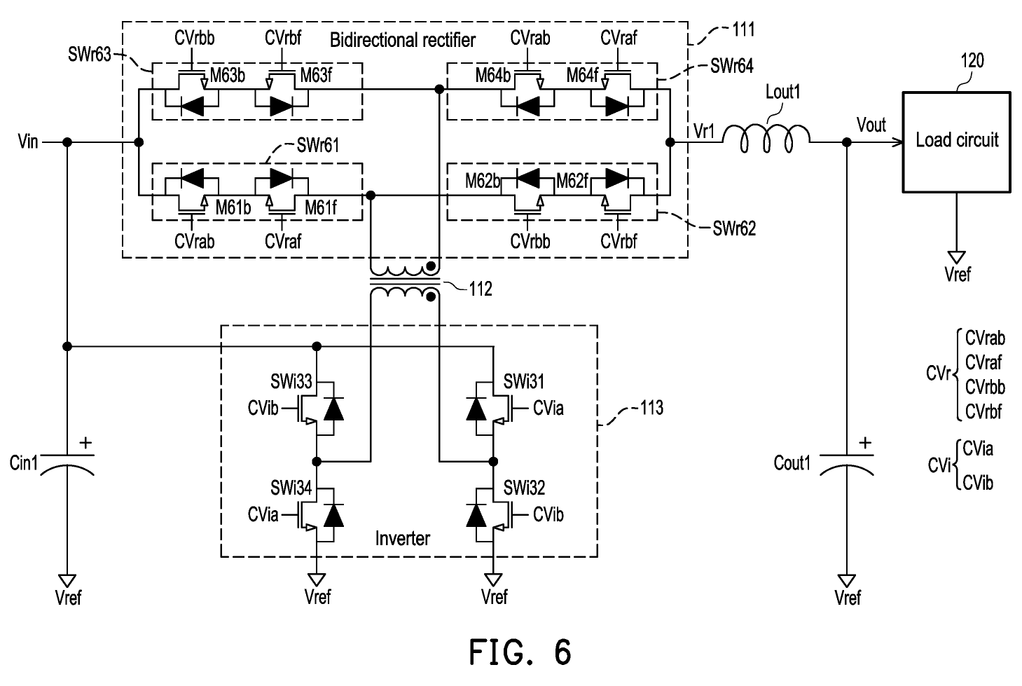

FIG. 6 is a circuit diagram of the bidirectional rectifier 111 and the inverter 113 according to another embodiment of the disclosure. The bidirectional rectifier 111 and the inverter 113 shown in FIG. 6 may serve as one of many implementation examples of the bidirectional rectifier 111 and the inverter 113 shown in FIG. 1. For the input capacitor Cin1, the bidirectional rectifier 111, the transformer 112, the inverter 113, the inductor Lout1, the output capacitor Cout1, and the load circuit 120 shown in FIG. 6, reference may be made to the related description of FIG. 1, so details will not be repeated here. The inverter 113 includes a power transistor SWi31, a power transistor SWi32, a power transistor SWi33, and a power transistor SWi34. The power transistors SWi31, SWi32, SWi33, and SWi34 shown in FIG. 6 may serve as one of many implementation examples of the power transistors SWi31, SWi32, SWi33, and SWi34 shown in FIG. 3. For the power transistors SWi31, SWi32, SWi33, and SWi34 shown in FIG. 6, reference may be made to the related description of FIG. 3, so details will not be repeated here. In the embodiment shown in FIG. 6, the power transistors SWi31, SWi32, SWi33, and SWi34 are all N-type metal-oxide-semiconductor (NMOS) transistors. FIG. 6 also illustrates the body diodes of the power transistors SWi31, SWi32, SWi33, and SWi34.

The bidirectional rectifier 111 shown in FIG. 6 includes a switch circuit SWr61, a switch circuit SWr62, a switch circuit SWr63, and a switch circuit SWr64. For the switch circuits SWr61, SWr62, SWr63, and SWr64, reference may be made to the related description of the switch circuits SWr31, SWr32, SWr33, and SWr34 shown in FIG. 3, so details will not be repeated here. In the embodiment shown in FIG. 6, the switch circuit SWr61 includes a transistor M61b and a transistor M61f, the switch circuit SWr62 includes a transistor M62b and a transistor M62f, the switch circuit SWr63 includes a transistor M63b and a transistor M63f, and the switch circuit SWr64 includes a transistor M64b and a transistor M64f. Based on actual design, for one of many implementation examples of the switch circuits SWr31, SWr32, SWr33, and SWr34 shown in FIG. 3, reference may be made to the switch circuits SWr61, SWr62, SWr63, and SWr64 shown in FIG. 6, and be extended by analogy.

The transistors M61b and M61f are connected in back-to-back series connection between the first end and the second end of the switch circuit SWr61. The transistors M62b and M62f are connected in back-to-back series connection between the first end and the second end of the switch circuit SWr62. The transistors M63b and M63f are connected in back-to-back series connection between the first end and the second end of the switch circuit SWr63. The transistors M64b and M64f are connected in back-to-back series connection between the first end and the second end of the switch circuit SWr64. In the embodiment shown in FIG. 6, the transistors M61b, M61f, M62b, M62f, M63b, M63f, M64b, and M64f are all NMOS transistors. FIG. 6 also illustrates the body diodes of the power transistors M61b, M61f, M62b, M62f, M63b, M63f, M64b, and M64f.

In the embodiment shown in FIG. 6, the control signal CVr includes control signals CVrab, CVraf, CVrbb, and CVrbf. In response to the power conversion device 110 operating during a first free-wheeling period in the boost mode, the control signals CVrab, CVraf, CVrbb, and CVrbf turn on the transistors M61b, M61f, M62b, M62f, M63b, M63f, M64b, and M64f, and the control signals CVia and CVib turn off the power transistors SWi31, SWi32, SWi33, and SWi34. In response to the power conversion device 110 operating during a first transient period (the first transient period of the boost mode is after the first free-wheeling period of the boost mode) in the boost mode, the control signals CVrab, CVraf, and CVrbb turn on the transistors M61b, M61f, M62b, M63b, M64b, and M64f, the control signal CVrbf turns off the transistors M62f and M63f, and the control signals CVia and CVib turn off the power transistors SWi31, SWi32, SWi33, and SWi34.

In response to the power conversion device 110 operating during a first conversion period (the first conversion period of the boost mode is after the first transient period of the boost mode) in the boost mode, the control signal CVia turns on the power transistors SWi31 and SWi34, the control signals CVrab, CVraf, and CVrbb turn on the transistors M61b, M61f, M62b, M63b, M64b, and M64f, the control signal CVib turns off the power transistors SWi32 and SWi33, and the control signal CVrbf turns off the transistors M62f and M63f. At this time, current flows from the conducting switch circuit SWr61 through the secondary winding of the transformer 112 to the conducting switch circuit SWr64. The bidirectional rectifier 111 rectifies the AC voltage Vac2 into a rectified voltage to the output end (the right end of the bidirectional rectifier 111) of the bidirectional rectifier 111. That is, the bidirectional rectifier 111 superimposes the input DC voltage Vin on the rectified voltage to serve as the adjusted DC voltage Vr1.

In response to the power conversion device 110 operating during a second transient period (the second transient of the boost mode is after the first conversion period of the boost mode) in the boost mode, the control signals CVrab, CVraf, and CVrbb turn on the transistors M61b, M61f, M62b, M63b, M64b, and M64f, the control signal CVrbf turns off the transistors M62f and M63f, and the control signals CVia and CVib turn off the power transistors SWi31, SWi32, SWi33, and SWi34. In response to the power conversion device 110 operating during a second free-wheeling period (the second free-wheeling period of the boost mode is after the second transient period of the boost mode) in the boost mode, the control signals CVrab, CVraf, CVrbb, and CVrbf turn on the transistors M61b, M61f, M62b, M62f, M63b, M63f, M64b, and M64f, and the control signals CVia and CVib turn off the power transistors SWi31, SWi32, SWi33, and SWi34. In response to the power conversion device 110 operating during a third transient period (the third transient period of the boost mode is after the second free-wheeling period of the boost mode) in the boost mode, the control signals CVrab, CVrbb, and CVrbf turn on the transistors M61b, M62b, M62f, M63b, M63f, and M64b, the control signal CVraf turns off the transistors M61f and M64f, and the control signals CVia and CVib turn off the power transistors SWi31, SWi32, SWi33, and SWi34.

In response to the power conversion device 110 operating during a second conversion period (the second conversion period of the boost mode is after the third transient period of the boost mode) in the boost mode, the control signal CVia turns off the power transistors SWi31 and SWi34, the control signal CVraf turns off the transistors M61f and M64f, the control signal CVib turns on the power transistors SWi32 and SWi33, and the control signals CVrab, CVrbb, and CVrbf turn on the transistors M61b, M62b, M62f, M63b, M63f, and M64b. At this time, current flows from the conducting switch circuit SWr63 through the secondary winding of the transformer 112 to the conducting switch circuit SWr62. The bidirectional rectifier 111 rectifies the AC voltage Vac2 into a rectified voltage to the output end (the right end of the bidirectional rectifier 111) of the bidirectional rectifier 111. That is, the bidirectional rectifier 111 superimposes the input DC voltage Vin on the rectified voltage as the adjusted DC voltage Vr1.

In response to the power conversion device 110 operating during a fourth transient period (the fourth transient of the boost mode is after the second conversion period of the boost mode) in the boost mode, the control signals CVrab, CVrbb, and CVrbf turn on the transistors M61b, M62b, M62f, M63b, M63f, and M64b, the control signal CVraf turns off the transistors M61f and M64f, and the control signals CVia and CVib turn off the power transistors SWi31, SWi32, SWi33, and SWi34. In response to the power conversion device 110 operating during a third free-wheeling period (the third free-wheeling period of the boost mode is after the fourth transient period of the boost mode) in the boost mode, the control signals CVrab, CVraf, CVrbb, and CVrbf turn on the transistors M61b, M61f, M62b, M62f, M63b, M63f, M64b, and M64f, and the control signals CVia and CVib turn off the power transistors SWi31, SWi32, SWi33, and SWi34. In summary, the bidirectional rectifier 111 may step up the input DC voltage Vin in the boost mode to generate the adjusted DC voltage Vr1 to the inductor Lout1.

In response to the power conversion device 110 operating during the first free-wheeling period in the buck mode, the control signals CVrab, CVraf, CVrbb, and CVrbf turn on the transistors M61b, M61f, M62b, M62f, M63b, M63f, M64b, and M64f, and the control signals CVia and CVib turn off the power transistors SWi31, SWi32, SWi33, and SWi34. In response to the power conversion device 110 operating during a first conversion period (the first conversion period of the buck mode is after the first free-wheeling period of the buck mode) in the buck mode, the control signal CVia turns off the power transistors SWi31 and SWi34, the control signal CVrbb turns off the transistors M62b and M63b, the control signal CVib turns on the power transistors SWi32 and SWi33, and the control signals CVrab, CVraf, and CVrbf turn on the transistors M61b, M61f, M62f, M63f, M64b, and M64f. At this time, current flows from the conducting switch circuit SWr64 through the secondary winding of the transformer 112 to the conducting switch circuit SWr61. The bidirectional rectifier 111 rectifies the AC voltage Vac2 into a rectified voltage to the input end (the left end of the bidirectional rectifier 111) of the bidirectional rectifier 111. That is, the bidirectional rectifier 111 subtracts the rectified voltage from the input DC voltage Vin as the adjusted DC voltage Vr1.

In response to the power conversion device 110 operating during the second free-wheeling period (the second free-wheeling period of the buck mode is after the first conversion period of the buck mode) in the buck mode, the control signals CVrab, CVraf, CVrbb, and CVrbf turn on the transistors M61b, M61f, M62b, M62f, M63b, M63f, M64b, and M64f, and the control signals CVia and CVib turn off the power transistors SWi31, SWi32, SWi33, and SWi34. In response to the power conversion device 110 operating during the second conversion period (the second conversion period of the buck mode is after the second free-wheeling period of the buck mode) in the buck mode, the control signal CVia turns on the power transistors SWi31 and SWi34, the control signals CVraf, CVrbb, and CVrbf turn on the transistors M61f, M62b, M62f, M63b, M63f, and M64f, the control signal CVib turns off the power transistors SWi32 and SWi33, and the control signal CVrab turns off the transistors M61b and M64b. In summary, the bidirectional rectifier 111 may step down the input DC voltage Vin in the buck mode to generate the adjusted DC voltage Vr1 to the inductor Lout1.

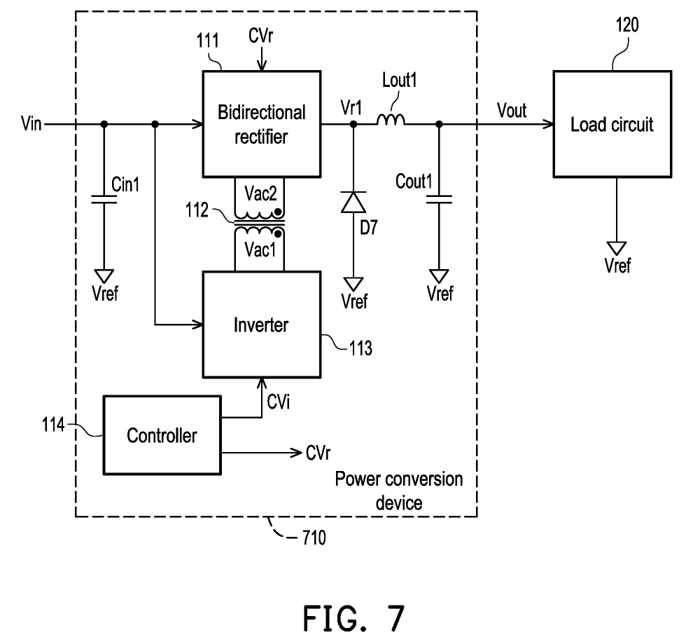

FIG. 7 is a schematic circuit block diagram of a power conversion device 710 according to another embodiment of the disclosure. In the embodiment shown in FIG. 7, the power conversion device 710 includes an input capacitor Cin1, a bidirectional rectifier 111, a transformer 112, an inverter 113, a controller 114, a diode D7, an inductor Lout1, and an output capacitor Cout1. For the input capacitor Cin1, bidirectional rectifier 111, transformer 112, inverter 113, controller 114, inductor Lout1, output capacitor Cout1, and load circuit 120 shown in FIG. 7, reference may be made to the related description of FIG. 1, so details will not be repeated here. In the embodiment shown in FIG. 7, a first end (for example, cathode) of a diode D7 is coupled to the first end of the inductor Lout1 and an output end of the bidirectional rectifier 111 to receive the adjusted DC voltage Vr1. A second end (for example, anode) of the diode D7 is coupled to the inverter 113, the input capacitor Cin1, and the output capacitor Cout1 to receive the reference voltage Vref. When performing a short circuit test, for example, when a power terminal (a connection terminal for receiving the output voltage Vout) of the load circuit 120 is short-circuited to a reference terminal (a connection terminal for receiving the reference voltage Vref) of the load circuit 120, the diode D7 may protect the bidirectional rectifier 111 from damage caused by short circuit current.

Although the disclosure has been disclosed above with embodiments, the embodiments are not intended to limit the disclosure. Persons having ordinary knowledge in the technical field may make slight changes and modifications without departing from the spirit and scope of the disclosure. Therefore, the protection scope of the disclosure shall be defined by the appended claims.

What is claimed is:

1. A power conversion device, comprising:
an inverter, wherein an input end of the inverter receives an input DC voltage, and the inverter converts the input DC voltage into a first AC voltage;
a transformer, wherein a primary winding of the transformer is coupled to an output end of the inverter to receive the first AC voltage, and a secondary winding of the transformer generates a second AC voltage;
a bidirectional rectifier coupled to the secondary winding of the transformer to receive the second AC voltage, wherein an input end of the bidirectional rectifier receives the input DC voltage, and the bidirectional rectifier uses the second AC voltage to adjust the input DC voltage to generate an adjusted DC voltage; and
an inductor, wherein a first end of the inductor is coupled to an output end of the bidirectional rectifier to receive the adjusted DC voltage, and a second end of the inductor provides an output voltage to a load circuit.

2. The power conversion device as claimed in claim 1, wherein
in response to the power conversion device operating during a conversion period, the inverter is enabled to convert the input DC voltage into the first AC voltage to the transformer, and the bidirectional rectifier uses the second AC voltage output by the transformer to adjust the input DC voltage to generate the adjusted DC voltage to the inductor, and
in response to the power conversion device operating during a free-wheeling period after the conversion period, the inverter is disabled and stops outputting the first AC voltage to the transformer, and the bidirectional rectifier uses the input DC voltage as the adjusted DC voltage to output to the inductor.

3. The power conversion device as claimed in claim 1, wherein the inverter comprises:
a first power transistor, wherein a first end of the first power transistor is coupled to an input end of the inverter to receive the input DC voltage, and a second end of the first power transistor is coupled to a first end of the primary winding of the transformer;
a second power transistor, wherein a first end of the second power transistor is coupled to the second end of the first power transistor, and a second end of the second power transistor receives a first reference voltage;
a third power transistor, wherein a first end of the third power transistor is coupled to the input end of the inverter to receive the input DC voltage, and a second end of the third power transistor is coupled to a second end of the primary winding of the transformer; and
a fourth power transistor, wherein a first end of the fourth power transistor is coupled to the second end of the third power transistor, and a second end of the fourth power transistor receives a second reference voltage.

4. The power conversion device as claimed in claim 3, wherein
in response to the power conversion device operating during a first conversion period, the first power transistor and the fourth power transistor are turned on, and the second power transistor and the third power transistor are turned off,
in response to the power conversion device operating during a first free-wheeling period after the first conversion period, the first power transistor, the second power transistor, the third power transistor, and the fourth power transistor are turned off,
in response to the power conversion device operating during a second conversion period after the first free-wheeling period, the first power transistor and the fourth power transistor are turned off, and the second power transistor and the third power transistor are turned on, and
in response to the power conversion device operating during a second free-wheeling period after the second conversion period, the first power transistor, the second power transistor, the third power transistor and the fourth power transistor are turned off.

5. The power conversion device as claimed in claim 3, wherein the bidirectional rectifier comprises:
a first switch circuit, wherein a first end of the first switch circuit is coupled to the input end of the bidirectional rectifier to receive the input DC voltage;
a second switch circuit, wherein a first end of the second switch circuit is coupled to a second end of the first switch circuit, and a second end of the second switch circuit is coupled to the output end of the bidirectional rectifier to provide the adjusted DC voltage;
a third switch circuit, wherein a first end of the third switch circuit is coupled to the input end of the bidirectional rectifier to receive the input DC voltage, a second end of the third switch circuit is coupled to a first end of the secondary winding of the transformer, and the second end of the first switch circuit is coupled to a second end of the secondary winding of the transformer; and
a fourth switch circuit, wherein a first end of the fourth switch circuit is coupled to the second end of the third switch circuit, and a second end of the fourth switch circuit is coupled to the output end of the bidirectional rectifier to provide the adjusted DC voltage.

6. The power conversion device as claimed in claim 5, wherein
in response to the power conversion device operating during a first conversion period in a boost mode, the first power transistor, the fourth power transistor, the first switch circuit, and the fourth switch circuit are turned on, and the second power transistor, the third power transistor, the second switch circuit, and the third switch circuit are turned off,
in response to the power conversion device operating during a first free-wheeling period in the boost mode, the first switch circuit, the second switch circuit, the third switch circuit, and the fourth switch circuit are turned on, and the first power transistor, the second power transistor, the third power transistor, and the fourth power transistor are turned off, wherein the first free-wheeling period is after the first conversion period,
in response to the power conversion device operating during a second conversion period in the boost mode, the first power transistor, the fourth power transistor, the first switch circuit, and the fourth switch circuit are turned off, and the second power transistor, the third power transistor, the second switch circuit, and the third switch circuit are turned on, wherein the second conversion period is after the first free-wheeling period, and
in response to the power conversion device operating during a second free-wheeling period in the boost mode, the first switch circuit, the second switch circuit, the third switch circuit, and the fourth switch circuit are turned on, and the first power transistor, the second power transistor, the third power transistor, and the fourth power transistor are turned off, wherein the second free-wheeling period is after the second conversion period.

7. The power conversion device as claimed in claim 5, wherein
in response to the power conversion device operating during a first conversion period in a buck mode, the first power transistor, the fourth power transistor, the second switch circuit, and the third switch circuit are turned on, and the second power transistor, the third power transistor, the first switch circuit, and the fourth switch circuit are turned off,
in response to the power conversion device operating during a first free-wheeling period in the buck mode, the first switch circuit, the second switch circuit, the third switch circuit, and the fourth switch circuit are turned on, and the first power transistor, the second power transistor, the third power transistor, and the fourth power transistor are turned off, wherein the first free-wheeling period is after the first conversion period,
in response to the power conversion device operating during a second conversion period in the buck mode, the first power transistor, the fourth power transistor, the second switch circuit, and the third switch circuit are turned off, and the second power transistor, the third power transistor, the first switch circuit, and the fourth switch circuit are turned on, wherein the second conversion period is after the first free-wheeling period, and
in response to the power conversion device operating during a second free-wheeling period in the buck mode, the first switch circuit, the second switch circuit, the third switch circuit, and the fourth switch circuit are turned on, and the first power transistor, the second power transistor, the third power transistor, and the fourth power transistor are turned off, wherein the second free-wheeling period is after the second conversion period.

8. The power conversion device as claimed in claim 5, wherein
the first switch circuit comprises a first transistor and a second transistor, the first transistor and the second transistor are connected in back-to-back series connection between the first end and the second end of the first switch circuit,
the second switch circuit comprises a third transistor and a fourth transistor, the third transistor and the fourth transistor are connected in back-to-back series connection between the first end and the second end of the second switch circuit,
the third switch circuit comprises a fifth transistor and a sixth transistor, the fifth transistor and the sixth transistor are connected in back-to-back series connection between the first end and the second end of the third switch circuit, and
the fourth switch circuit comprises a seventh transistor and an eighth transistor, and the seventh transistor and the eighth transistor are connected in back-to-back series connection between the first end and the second end of the fourth switch circuit.

9. The power conversion device as claimed in claim 8, wherein
in response to the power conversion device operating during a first free-wheeling period in a boost mode, the first transistor, the second transistor, the third transistor, the fourth transistor, the fifth transistor, the sixth transistor, the seventh transistor, and the eighth transistor are turned on, and the first power transistor, the second power transistor, the third power transistor, and the fourth power transistor are turned off,
in response to the power conversion device operating during a first transient period in the boost mode, the first transistor, the second transistor, the third transistor, the fifth transistor, the seventh transistor, and the eighth transistor are turned on, and the fourth transistor, the sixth transistor, the first power transistor, the second power transistor, the third power transistor, and the fourth power transistor are turned off, wherein the first transient period is after the first free-wheeling period,
in response to the power conversion device operating during a first conversion period in the boost mode, the first power transistor, the fourth power transistor, the first transistor, the second transistor, the third transistor, the fifth transistor, the seventh transistor, and the eighth transistor are turned on, and the second power transistor, the third power transistor, the fourth transistor, and the sixth transistor are turned off, wherein the first conversion period is after the first transient period,
in response to the power conversion device operating during a second transient period in the boost mode, the first transistor, the second transistor, the third transistor, the fifth transistor, the seventh transistor, and the eighth transistor are turned on, and the fourth transistor, the sixth transistor, the first power transistor, the second power transistor, the third power transistor, and the fourth power transistor are turned off, wherein the second transient period is after the first conversion period,
in response to the power conversion device operating during a second free-wheeling period in the boost mode, the first transistor, the second transistor, the third transistor, the fourth transistor, the fifth transistor, the sixth transistor, the seventh transistor, and the eighth transistor are turned on, and the first power transistor, the second power transistor, the third power transistor, and the fourth power transistor are turned off, wherein the second free-wheeling period is after the second transient period,
in response to the power conversion device operating during a third transient period in the boost mode, the first transistor, the third transistor, the fourth transistor, the fifth transistor, the sixth transistor, and the seventh transistor are turned on, and the second transistor, the eighth transistor, the first power transistor, the second power transistor, the third power transistor, and the fourth power transistor are turned off, wherein the third transient period is after the second free-wheeling period,
in response to the power conversion device operating during a second conversion period in the boost mode, the first power transistor, the fourth power transistor, the second transistor, and the eighth transistor are turned off, and the second power transistor, the third power transistor, the first transistor, the third transistor, the fourth transistor, the fifth transistor, the sixth transistor, and the seventh transistor are turned on, wherein the second conversion period is after the third transient period,
in response to the power conversion device operating during a fourth transient period in the boost mode, the first transistor, the third transistor, the fourth transistor, the fifth transistor, the sixth transistor, and the seventh transistor are turned on, and the second transistor, the eighth transistor, the first power transistor, the second power transistor, the third power transistor, and the fourth power transistor are turned off, wherein the fourth transient period is after the second conversion period, and
in response to the power conversion device operating during a third free-wheeling period in the boost mode, the first transistor, the second transistor, the third transistor, the fourth transistor, the fifth transistor, the sixth transistor, the seventh transistor, and the eighth transistor are turned on, and the first power transistor, the second power transistor, the third power transistor, and the fourth power transistor are turned off, wherein the third free-wheeling period is after the fourth transient period.

10. The power conversion device as claimed in claim 8, wherein
in response to the power conversion device operating during a first free-wheeling period in a buck mode, the first transistor, the second transistor, the third transistor, the fourth transistor, the fifth transistor, the sixth transistor, the seventh transistor, and the eighth transistor are turned on, and the first power transistor, the second power transistor, the third power transistor, and the fourth power transistor are turned off,
in response to the power conversion device operating during a first conversion period in the buck mode, the first power transistor, the fourth power transistor, the third transistor, and the fifth transistor are turned off, and the second power transistor, the third power transistor, the first transistor, the second transistor, the fourth transistor, the sixth transistor, the seventh transistor, and the eighth transistor are turned on, wherein the first conversion period is after the first free-wheeling period,
in response to the power conversion device operating during a second free-wheeling period in the buck mode, the first transistor, the second transistor, the third transistor, the fourth transistor, the fifth transistor, the sixth transistor, the seventh transistor, and the eighth transistor are turned on, and the first power transistor, the second power transistor, the third power transistor, and the fourth power transistor are turned off, wherein the second free-wheeling period is after the first conversion period, and
in response to the power conversion device operating during a second conversion period in the buck mode, the first power transistor, the fourth power transistor, the second transistor, the third transistor, the fourth transistor, the fifth transistor, the sixth transistor, and the eighth transistor are turned on, and the second power transistor, the third power transistor, the first transistor, and the seventh transistor are turned off, wherein the second conversion period is after the second free-wheeling period.

11. The power conversion device as claimed in claim 1, further comprising:
an input capacitor, wherein a first end of the input capacitor is coupled to the input end of the inverter and the input end of the bidirectional rectifier to receive the input DC voltage, and a second end of the input capacitor receives a reference voltage.

12. The power conversion device as claimed in claim 1, further comprising:
an output capacitor, wherein a first end of the output capacitor is coupled to the second end of the inductor, and a second end of the output capacitor receives a reference voltage.

13. The power conversion device as claimed in claim 1, further comprising:
a diode, wherein a first end of the diode is coupled to the first end of the inductor, and a second end of the diode receives a reference voltage.

14. An operation method of a power conversion device, comprising:
converting, by an inverter of the power conversion device, an input DC voltage into a first AC voltage to a primary winding of a transformer of the power conversion device, wherein an input end of the inverter receives the input DC voltage, and the primary winding of the transformer is coupled to an output end of the inverter to receive the first AC voltage;
generating, by a secondary winding of the transformer, a second AC voltage to a bidirectional rectifier of the power conversion device, wherein the bidirectional rectifier is coupled to the secondary winding of the transformer to receive the second AC voltage, and an input end of the bidirectional rectifier receives the input DC voltage;
using, by the bidirectional rectifier, the second AC voltage to adjust the input DC voltage to generate an adjusted DC voltage to an inductor of the power conversion device, wherein a first end of the inductor is coupled to an output end of the bidirectional rectifier to receive the adjusted DC voltage; and
providing, by a second end of the inductor, an output voltage to a load circuit.

15. The operation method as claimed in claim 14, further comprising:
in response to the power conversion device operating during a conversion period, enabling the inverter to convert the input DC voltage into the first AC voltage to the transformer, and using, by the bidirectional rectifier, the second AC voltage output by the transformer to adjust the input DC voltage to generate the adjusted DC voltage to the inductor; and
in response to the power conversion device operating during a free-wheeling period after the conversion period, disabling the inverter to stop outputting the first AC voltage to the transformer, and using, by the bidirectional rectifier, the input DC voltage as the adjusted DC voltage to output to the inductor.

16. The operation method as claimed in claim 14, further comprising:
in response to the power conversion device operating during a first conversion period, turning on a first power transistor of the inverter and a fourth power transistor of the inverter, and turning off a second power transistor of the inverter and a third power transistor of the inverter, wherein a first end of the first power transistor is coupled to the input end of the inverter to receive the input DC voltage, a second end of the first power transistor is coupled to a first end of the primary winding of the transformer, a first end of the second power transistor is coupled to the second end of the first power transistor, a second end of the second power transistor receives a first reference voltage, a first end of the third power transistor is coupled to the input end of the inverter to receive the input DC voltage, a second end of the third power transistor is coupled to a second end of the primary winding of the transformer, a first end of the fourth power transistor is coupled to the second end of the third power transistor, and a second end of the fourth power transistor receives a second reference voltage;
in response to the power conversion device operating during a first free-wheeling period after the first conversion period, turning off the first power transistor, the second power transistor, the third power transistor, and the fourth power transistor;
in response to the power conversion device operating during a second conversion period after the first free-wheeling period, turning off the first power transistor and the fourth power transistor, and turning on the second power transistor and the third power transistor; and
in response to the power conversion device operating during a second free-wheeling period after the second conversion period, turning off the first power transistor, the second power transistor, the third power transistor, and the fourth power transistor.

17. The operation method as claimed in claim 14, further comprising:
in response to the power conversion device operating during a first conversion period in a boost mode, turning on a first power transistor of the inverter, a fourth power transistor of the inverter, a first switch circuit of the bidirectional rectifier, and a fourth switch circuit of the bidirectional rectifier, and turning off a second power transistor of the inverter, a third power transistor of the inverter, a second switch circuit of the bidirectional rectifier, and a third switch circuit of the bidirectional rectifier, wherein a first end of the first power transistor is coupled to the input end of the inverter to receive the input DC voltage, a second end of the first power transistor is coupled to a first end of the primary winding of the transformer, a first end of the second power transistor is coupled to the second end of the first power transistor, a second end of the second power transistor receives a first reference voltage, a first end of the third power transistor is coupled to the input end of the inverter to receive the input DC voltage, a second end of the third power transistor is coupled to a second end of the primary winding of the transformer, a first end of the fourth power transistor is coupled to the second end of the third power transistor, a second end of the fourth power transistor receives a second reference voltage, a first end of the first switch circuit is coupled to the input end of the bidirectional rectifier to receive the input DC voltage, a first end of the second switch circuit is coupled to a second end of the first switch circuit, a second end of the second switch circuit is coupled to the output end of the bidirectional rectifier to provide the adjusted DC voltage, a first end of the third switch circuit is coupled to the input end of the bidirectional rectifier to receive the input DC voltage, a second end of the third switch circuit is coupled to a first end of the secondary winding of the transformer, the second end of the first switch circuit is coupled to a second end of the secondary winding of the transformer, a first end of the fourth switch circuit is coupled to the second end of the third switch circuit, and a second end of the fourth switch circuit is coupled to the output end of the bidirectional rectifier to provide the adjusted DC voltage;
in response to the power conversion device operating during a first free-wheeling period in the boost mode, turning on the first switch circuit, the second switch circuit, the third switch circuit, and the fourth switch circuit, and turning off the first power transistor, the second power transistor, the third power transistor, and the fourth power transistor, wherein the first free-wheeling period is after the first conversion period;
in response to the power conversion device operating during a second conversion period in the boost mode, turning off the first power transistor, the fourth power transistor, the first switch circuit, and the fourth switch circuit, and turning on the second power transistor, the third power transistor, the second switch circuit, and the third switch circuit, wherein the second conversion period is after the first free-wheeling period; and
in response to the power conversion device operating during a second free-wheeling period in the boost mode, turning on the first switch circuit, the second switch circuit, the third switch circuit, and the fourth switch circuit, and turning off the first power transistor, the second power transistor, the third power transistor, and the fourth power transistor, wherein the second free-wheeling period is after the second conversion period.

18. The operation method as claimed in claim 17, wherein
in response to the power conversion device operating during a first conversion period in a buck mode, turning on the first power transistor, the fourth power transistor, the second switch circuit, and the third switch circuit, and turning off the second power transistor, the third power transistor, the first switch circuit, and the fourth switch circuit,
in response to the power conversion device operating during a first free-wheeling period in the buck mode, turning on the first switch circuit, the second switch circuit, the third switch circuit, and the fourth switch circuit, and turning off the first power transistor, the second power transistor, the third power transistor, and the fourth power transistor, wherein the first free-wheeling period is after the first conversion period,
in response to the power conversion device operating during a second conversion period in the buck mode, turning off the first power transistor, the fourth power transistor, the second switch circuit, and the third switch circuit, and turning on the second power transistor, the third power transistor, the first switch circuit, and the fourth switch circuit, wherein the second conversion period is after the first free-wheeling period; and
in response to the power conversion device operating during a second free-wheeling period in the buck mode, turning on the first switch circuit, the second switch circuit, the third switch circuit, and the fourth switch circuit, and turning off the first power transistor, the second power transistor, the third power transistor, and the fourth power transistor, wherein the second free-wheeling period is after the second conversion period.

19. The operation method as claimed in claim 14, further comprising:
in response to the power conversion device operating during a first free-wheeling period in a boost mode, turning on a first transistor, a second transistor, a third transistor, a fourth transistor, a fifth transistor, a sixth transistor, a seventh transistor, and an eighth transistor of the bidirectional rectifier, and turning off a first power transistor, a second power transistor, a third power transistor, and a fourth power transistor of the inverter, wherein a first end of the first power transistor is coupled to the input end of the inverter to receive the input DC voltage, a second end of the first power transistor is coupled to a first end of the primary winding of the transformer, a first end of the second power transistor is coupled to the second end of the first power transistor, a second end of the second power transistor receives a first reference voltage, a first end of the third power transistor is coupled to the input end of the inverter to receive the input DC voltage, a second end of the third power transistor is coupled to a second end of the primary winding of the transformer, a first end of the fourth power transistor is coupled to the second end of the third power transistor, a second end of the fourth power transistor receives a second reference voltage, a first end of the first switch circuit is coupled to the input end of the bidirectional rectifier to receive the input DC voltage, a second end of the first switch circuit is coupled to a first end of the secondary winding of the transformer, a first end of the second switch circuit is coupled to the second end of the first switch circuit, a second end of the second switch circuit is coupled to the output end of the bidirectional rectifier to provide the adjusted DC voltage, a first end of the third switch circuit is coupled to the input end of the bidirectional rectifier to receive the input DC voltage, a second end of the third switch circuit is coupled to a second end of the secondary winding of the transformer, a first end of the fourth switch circuit is coupled to the second end of the third switch circuit, a second end of the fourth switch circuit is coupled to the output end of the bidirectional rectifier to provide the adjusted DC voltage, the first switch circuit comprises the first transistor and the second transistor, the first transistor and the second transistor are connected in back-to-back series connection between the first end and the second end of the first switch circuit, the second switch circuit comprises the third transistor and the fourth transistor, the third transistor and the fourth transistor are connected in back-to-back series connection between the first end and the second end of the second switch circuit, the third switch circuit comprises the fifth transistor and the sixth transistor, the fifth transistor and the sixth transistor are connected in back-to-back series connection between the first end and the second end of the third switch circuit, the fourth switch circuit comprises the seventh transistor and the eighth transistor, and the seventh transistor and the eighth transistor are connected in back-to-back series connection between the first end and the second end of the fourth switch circuit;
in response to the power conversion device operating during a first transient period in the boost mode, turning on the first transistor, the second transistor, the third transistor, the fifth transistor, the seventh transistor, and the eighth transistor, and turning off the fourth transistor, the sixth transistor, the first power transistor, the second power transistor, the third power transistor, and the fourth power transistor, wherein the first transient period is after the first free-wheeling period;
in response to the power conversion device operating during a first conversion period in the boost mode, turning on the first power transistor, the fourth power transistor, the first transistor, the second transistor, the third transistor, the fifth transistor, the seventh transistor, and the eighth transistor, and turning off the second power transistor, the third power transistor, the fourth transistor, and the sixth transistor, wherein the first conversion period is after the first transient period;
in response to the power conversion device operating during a second transient period in the boost mode, turning on the first transistor, the second transistor, the third transistor, the fifth transistor, the seventh transistor, and the eighth transistor, and turning off the fourth transistor, the sixth transistor, the first power transistor, the second power transistor, the third power transistor, and the fourth power transistor, wherein the second transient period is after the first conversion period;
in response to the power conversion device operating during a second free-wheeling period in the boost mode, turning on the first transistor, the second transistor, the third transistor, the fourth transistor, the fifth transistor, the sixth transistor, the seventh transistor, and the eighth transistor, and turning off the first power transistor, the second power transistor, the third power transistor, and the fourth power transistor, wherein the second free-wheeling period is after the second transient period;
in response to the power conversion device operating during a third transient period in the boost mode, turning on the first transistor, the third transistor, the fourth transistor, the fifth transistor, the sixth transistor, and the seventh transistor, and turning off the second transistor, the eighth transistor, the first power transistor, the second power transistor, the third power transistor, and the fourth power transistor, wherein the third transient period is after the second free-wheeling period;
in response to the power conversion device operating during a second conversion period in the boost mode, turning off the first power transistor, the fourth power transistor, the second transistor, and the eighth transistor, and turning on the second power transistor, the third power transistor, the first transistor, the third transistor, the fourth transistor, the fifth transistor, the sixth transistor, and the seventh transistor, wherein the second conversion period is after the third transient period;
in response to the power conversion device operating during a fourth transient period in the boost mode, turning on the first transistor, the third transistor, the fourth transistor, the fifth transistor, the sixth transistor, and the seventh transistor, and turning off the second transistor, the eighth transistor, the first power transistor, the second power transistor, the third power transistor and the fourth power transistor, wherein the fourth transient period is after the second conversion period; and
in response to the power conversion device operating during a third free-wheeling period in the boost mode, turning on the first transistor, the second transistor, the third transistor, the fourth transistor, the fifth transistor, the sixth transistor, the seventh transistor, and the eighth transistor, and turning off the first power transistor, the second power transistor, the third power transistor, and the fourth power transistor, wherein the third free-wheeling period is after the fourth transient period.

20. The operation method as claimed in claim 19, further comprising:
in response to the power conversion device operating during a first free-wheeling period in a buck mode, turning on the first transistor, the second transistor, the third transistor, the fourth transistor, the fifth transistor, the sixth transistor, the seventh transistor, and the eighth transistor, and turning off the first power transistor, the second power transistor, the third power transistor, and the fourth power transistor;
in response to the power conversion device operating during a first conversion period in the buck mode, turning off the first power transistor, the fourth power transistor, the third transistor, and the fifth transistor, and turning on the second power transistor, the third power transistor, the first transistor, the second transistor, the fourth transistor, the sixth transistor, the seventh transistor, and the eighth transistor, wherein the first conversion period is after the first free-wheeling period;
in response to the power conversion device operating during a second free-wheeling period in the buck mode, turning on the first transistor, the second transistor, the third transistor, the fourth transistor, the fifth transistor, the sixth transistor, the seventh transistor, and the eighth transistor, and turning off the first power transistor, the second power transistor, the third power transistor and the fourth power transistor, wherein the second free-wheeling period is after the first conversion period; and
in response to the power conversion device operating during a second conversion period in the buck mode, turning on the first power transistor, the fourth power transistor, the second transistor, the third transistor, the fourth transistor, the fifth transistor, the sixth transistor, and the eighth transistor, and turning off the second power transistor, the third power transistor, the first transistor, and the seventh transistor, wherein the second conversion period is after the second free-wheeling period.

21. A power conversion device, comprising:
a battery module;
an inverter connected in parallel with the battery module;
a transformer having a primary winding and a secondary winding, wherein the primary winding is coupled to the inverter;
a rectifier connected in series with the battery module and coupled to the secondary winding of the transformer; and
an inductor electrically connected to the rectifier.

22. The power conversion device as claimed in claim 21, wherein the inductor is electrically connected to an output end of the rectifier.

23. The power conversion device as claimed in claim 21, further comprising:
an input capacitor connected in parallel with the inverter and electrically connected to an input end of the rectifier.

24. The power conversion device as claimed in claim 21, further comprising:
an output capacitor coupled to the inductor.

25. The power conversion device as claimed in claim 21, further comprising:
a diode, wherein a first end of the diode is coupled to the rectifier, and a second end of the diode is coupled to the inverter.
